(19) United States
(12) Patent Application Publication
(10) Pub. No.: US 2008/0003470 A1
(43) Pub. Date: Jan. 3, 2008

(54) HYDROGEN STORAGE PROCESS AND APPARATUS THEREFOR

(75) Inventors: John C. Christenson, Kokomo, IN (US); Peter J. Schubert, Naperville, IL (US)

Correspondence Address: HARTMAN & HARTMAN, P.C., 552 EAST 700 NORTH, VALPARAISO, IN, 46383, US

(73) Assignee: PACKER ENGINEERING, INC., Naperville, IL (US)

(21) Appl. No.: 11/764,364

(22) Filed: Jun. 18, 2007

Related U.S. Application Data
(60) Provisional application No. 60/814,397, filed on Jun. 16, 2006.

(51) Int. Cl. H01M 8/04; H01M 8/00

(52) U.S. Cl. 429/17; 429/12

(57) ABSTRACT

A hydrogen storage process that utilizes a porous hydrogen storage medium capable of adsorbing hydrogen atoms, and an apparatus for carrying out the process. The process entails applying a charge to the storage medium while displacing one or more hydrogen atoms stored on the storage medium to create one or more danglings bond on the storage medium, and then replacing the hydrogen atoms displaced from the storage medium with placeholders, thereby preventing the dangling bonds from bonding to adjacent dangling bonds within the storage medium.

### CROSS REFERENCE TO RELATED APPLICATIONS

This application claims the benefit of U.S. Provisional Application No. 60/814,397, filed Jun. 16, 2006, the contents of which are incorporated herein by reference.

### STATEMENT REGARDING FEDERALLY SPONSORED RESEARCH

This invention was made with United States Government support from Edison Materials and Technology Center (EMTEC), Contract No. EFC-H2-3-1C. The Government has certain rights in this invention.

### BACKGROUND OF THE INVENTION

The present invention relates to hydrogen storage systems and processes. More particular, the present invention relates to hydrogen storage systems that utilize a porous hydrogen storage matrix material capable of adsorbing hydrogen atoms, and to a process and processing apparatus for maintaining the integrity of the matrix material by providing placeholders for hydrogen atoms desorbed from the matrix material.

Hydrogen-based fuel cell technologies are being considered for a wide variety of power applications, including but not limited to mobile applications such as vehicles as an attractive alternative to the use of petroleum-based products. Hydrogen-based fuel cells are also readily adaptable for use as energy sources in numerous and such diverse applications as cellular phones to space ships. They have the further desirable attribute of producing water vapor as their only byproduct and are thus environmentally benign.

Efficient storage of hydrogen is vitally important for cost-effective system implementation. When compared to storage for conventional chemical fuels or electric energy sources, existing hydrogen storage technologies lack the convenience of gasoline for delivery and storage capacity (energy density per unit weight), and lack the flexibility of electrical energy stored in batteries and capacitors. Therefore, for fuel cells to reach their full commercial potential, improved hydrogen storage technologies are needed.

Prior methods of storing hydrogen fall broadly into two categories. The first category involves storing hydrogen chemically within a convenient chemical molecule, usually an aliphatic organic compound such as methane, octane, etc., and then pre-processing the fuel as needed, such as by catalytic reforming, to release elemental hydrogen plus carbon oxides. This method suffers two important drawbacks: carbon dioxide byproduct is a “greenhouse gas” that some believe contributes to global warming and is therefore environmentally undesirable; and the additional weight of the chemical molecule and the reformer reduce the efficiency of the entire process, making it less attractive from a cost and performance standpoint.

The second category involves mechanical or adsorptive storage of elemental hydrogen in one of three forms: compressed gas, cryogenically-refrigerated liquid, or chemisorbed onto active surfaces. Of these methods, compressed gas storage is the most straightforward and is a mature technology. However, compressed gas cylinders are quite heavy, needing sufficient strength to withstand pressures of many thousands of pounds per square inch. This weight is a considerable drawback for portable applications, and in any usage compressed gas cylinders must be treated with care because they represent a safety hazard.

Cryogenic storage of hydrogen is also well known, being used in industrial plants and as a rocket fuel. Liquid hydrogen is remarkably dense from a specific energy point of view (kilowatts per kilogram), but requires a considerable amount of additional energy to maintain the nearly absolute zero temperatures needed to keep hydrogen in a liquid state. Liquid hydrogen also requires a heavy mass of insulation, and these factors conspire to make cryogenic storage impractical for portable and small-scale applications.

Chemisorption as used herein means the adsorption of a given molecule onto an active surface, typically of a solid or a solid matrix. Chemisorption is typically reversible, although the energy of adsorption and the energy of desorption are usually different. Various catalysts and surface preparations are possible, providing a wide range of possible chemistries and surface properties for a given storage problem. Chemisorption of hydrogen has been studied extensively, and substances such as metal hydrides, palladium, and carbon nanotubes or activated carbon have been used to adsorb and desorb hydrogen.

Prior hydrogen chemisorption techniques have fallen short of the goals of efficiency, convenience, and low system cost for several reasons. In some materials, such as carbon nanotubes, the efficiency of hydrogen adsorbed per unit weight of matrix is moderate, but the method of desorption requires high heat, which brings about danger of combustion. Additionally, the present cost of carbon nanostructures is relatively high, and control over material properties can be quite difficult in high-volume manufacturing. In the case of metal hydrides, metal oxides, and other inorganic surfaces, storage efficiencies typically are lower and the adsorption/desorption process is highly dependent upon exacting chemistry. These factors combine to make such approaches less than sufficiently robust for many commercial applications.

Hydrogenated surfaces in silicon have also been employed, as disclosed in U.S. Pat. Nos. 5,604,162, 5,605,171, and 5,765,680, the disclosures of which are incorporated herein by reference. In each of these references, the adsorbed molecule is the radioactive hydrogen isotope tritium (³H), and the objective is the storage of this isotope to enable its safe transport, typically to a waste handling or storage facility, or to serve as a means for providing radioactive energy to power a light source. These prior methods of chemisorption do not, however, provide for desorption of hydrogen from a silicon storage medium. In fact, conventional methods of chemisorption are generally designed to prevent desorption. Further, these conventional methods of chemisorption fail to teach methods by which the storage capacity of a silicon matrix can be increased.

As a solution to the forgoing, a system for storage and retrieval of elemental hydrogen on a porous silicon media is described in U.S. Published Patent Application No. 2004/0241507 to Schubert et al., the disclosure of which is incorporated herein by reference. Porous silicon (also known as nano-porous silicon, or npSi) is a particularly attractive candidate as solid-state storage media for hydrogen, such as when storing hydrogen for use as a fuel in internal combustion engines, fuel cells, etc., because of its ability to adsorb (bond) relatively large amounts of hydrogen, generally about six to seven percent hydrogen by weight. Furthermore, porosity can be readily formed in silicon using essentially any porous silicon etch method, including electrochemical etching and purely chemical etching. The etching process creates bond sites on the surfaces of the porous silicon matrix at which hydrogen atoms can be adsorbed (bonded) for storage and later desorbed (released) for use.

Although high surface area silicon matrices can be made to store hydrogen and release hydrogen as taught by Schubert et al., some methods of hydrogen release can disadvantageously cause the silicon matrix to store less hydrogen each time the silicon matrix is recharged. It would be desirable if the matrix was capable of nearly complete recharging with every cycle over the life span of the matrix material.

Certain existing recharge methods consume portions of the silicon matrix material during recharge, with the resulting loss of silicon atoms in the matrix translating into a loss of storage media for hydrogen. Furthermore, certain methods of releasing hydrogen from the silicon matrix can allow silicon dangling bonds that are in close proximity to each other at the silicon matrix surface to form silicon-silicon bonds. In addition to lowering the number of available bond sites for hydrogen during a subsequent recharge, silicon-silicon bond formation may deleteriously change the structure of the silicon matrix. Techniques are known that can break the silicon-silicon bonds and perhaps make bond sites available once again to store hydrogen. However, such techniques require the addition of energy to the storage system, which reduces the net output of usable energy from the system and translates into a less efficient storage system. Furthermore, excessive bonding of the surface silicon dangling bonds to form silicon-silicon bonds caused by some release methods can collapse the silicon storage media matrix. A collapse of the matrix can result in a two order of magnitude reduction in hydrogen storage capacity, and may even be irreversible, as noted in Farjas et al., “Calorimetry of Hydrogen Desorption from a-Si Nanoparticles,” Phys. Rev. B, 65, (2002) 115403.

### BRIEF SUMMARY OF THE INVENTION

The present invention provides a hydrogen storage process that utilizes a porous hydrogen storage medium capable of adsorbing hydrogen atoms, and an apparatus for carrying out the process. The process and apparatus maintain the integrity of the storage medium during hydrogen release from the storage medium by providing placeholders for hydrogen atoms desorbed from the storage medium.

The hydrogen storage process entails applying a charge to the storage medium while displacing one or more hydrogen atoms stored on the storage medium to create one or more danglings bond on the storage medium, and then replacing the hydrogen atoms displaced from the storage medium with placeholders, thereby preventing the dangling bonds from bonding to adjacent dangling bonds within the storage medium.

The processing apparatus includes means for applying a charge to the storage medium, means for displacing at least one hydrogen atom stored on the storage medium to create at least one dangling bond on the storage medium, and means for replacing the hydrogen atom displaced from the storage medium with a placeholder, thereby preventing the dangling bond from bonding to an adjacent dangling bond within the storage medium.

According to a preferred aspect of this invention, by preventing dangling bonds of the storage medium from bonding to adjacent dangling bonds created by hydrogen release from the storage medium, the structural integrity of the storage medium can be maintained, as well as the hydrogen storage capacity of the medium.

Other objects and advantages of this invention will be better appreciated from the following detailed description.

### BRIEF DESCRIPTION OF THE DRAWINGS

FIG. 1 schematically represents a porous silicon storage material at a molecular level, and depicts the material as having silicon dangling bonds that were exposed by removal of hydrogen atoms from the material in accordance with embodiments of the present invention.

FIG. 2 schematically represents an apparatus suitable for carrying out a process in accordance with an embodiment of the present invention.

### DETAILED DESCRIPTION OF THE INVENTION

The present invention uses electrostatic charges to replace hydrogen atoms desorbed from a silicon storage matrix, causing proximate silicon structures to repel one another and thereby conserving the silicon matrix. Collapse of the matrix is thus prevented while enabling the matrix to be recharged with hydrogen.

In the following discussion, nano-porous silicon (npSi) will be the focus as a solid-state storage material for hydrogen, though it should be appreciated that other materials may be used in place of silicon, for example, germanium. Nano-porous silicon is a particularly attractive candidate as solid-state storage media for hydrogen, such as when storing hydrogen for use as a fuel in internal combustion engines, fuel cells, etc., because of its ability to adsorb (bond) relatively large amounts of hydrogen, generally about six to seven percent hydrogen by weight. Furthermore, porosity can be readily formed in silicon using essentially any porous silicon etch method, including electrochemical etching and purely chemical etching.

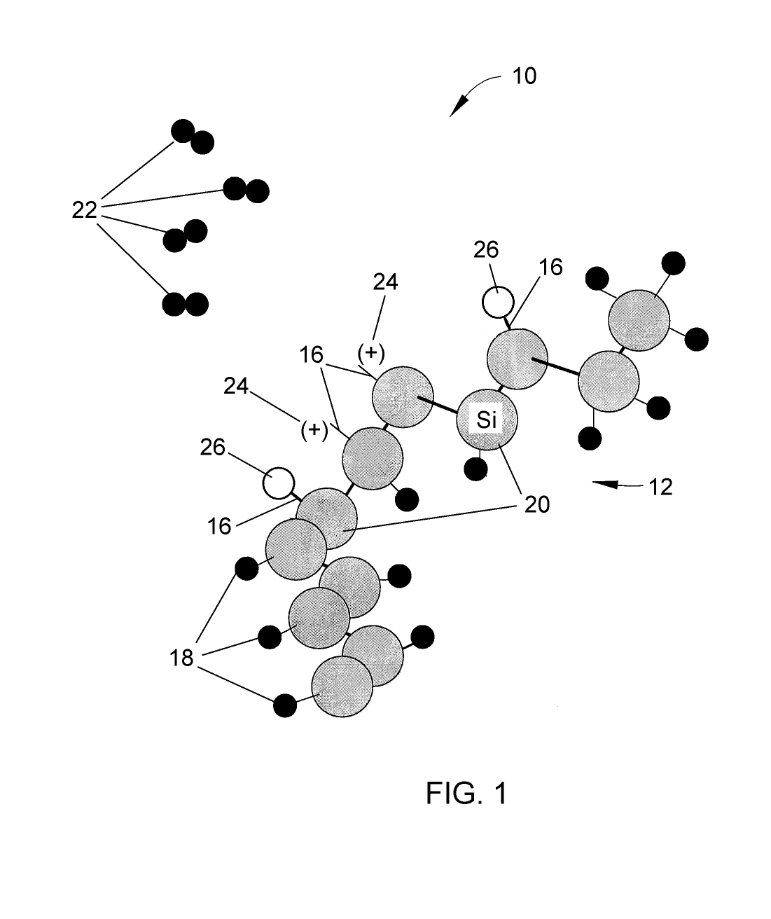

FIG. 1 schematically represents a fragment of a npSi matrix 10, and illustrates several of the points discussed below. The precise atomic arrangement of porous silicon is not necessarily made of a single repeatable unit cell, as in a single crystal, so the configuration of atoms in FIG. 1 is meant to express one representative formation of matter. Other configurations exist, and it will be realized that this embodiment is meant to teach, but not restrict, the present invention. In FIG. 1, a filament 12 at the surface of the npSi matrix 10 is shown as having silicon dangling bonds 16 exposed by the desorption of hydrogen atoms 18 (dehydrogenation) from the matrix 10. Elsewhere, molecular hydrogen atoms 18 are shown bonded to some of the silicon atoms 20 of the matrix 10, whereas hydrogen atoms released from the matrix 10 are shown as being released as molecular hydrogen 22. As known in the art, the hydrogen atoms 18 can be desorbed from the matrix 10 by the application of heat energy, light energy, electrical energy, or a combination thereof. The applied light energy preferably comprises infrared (IR) energy if a catalyst is present, or a combination of IR and ultraviolet (UV) light in the absence of a catalyst.

In the process of the present invention, desorption of hydrogen atoms 18 from the npSi matrix 10 occurs while a charge is applied to the matrix 10, and hydrogen atoms 18 displaced from the matrix 10 are replaced with hydrogen placeholders to preserve the structure of the matrix 10. The hydrogen placeholders can be electrical charges 24 or atoms 26. If the former, the electrical charges 24 are preferably positive charges, and if the latter the atoms 26 are preferably positively-charged ions of similar size to hydrogen atoms, such as lithium or boron atoms. The charge can be applied to the matrix 10 using electrodes and an electrical power source.

Application of a charge to the silicon storage matrix 10 causes adjacent silicon structures to repel one another, similar to the mutual repulsion of metal foil leaves of an electroscope. Bond sites and other portions of the matrix 10 from which hydrogen atoms 18 have been released are effectively passivated, preventing silicon dangling bonds 16 in close proximity to each other from forming silicon-silicon bonds, and thus preserving the structure of the matrix material. As a result, the matrix 10 is substantially unchanged after hydrogen desorption and retains its ability to bond with and store hydrogen atoms during a subsequent recharge operation.

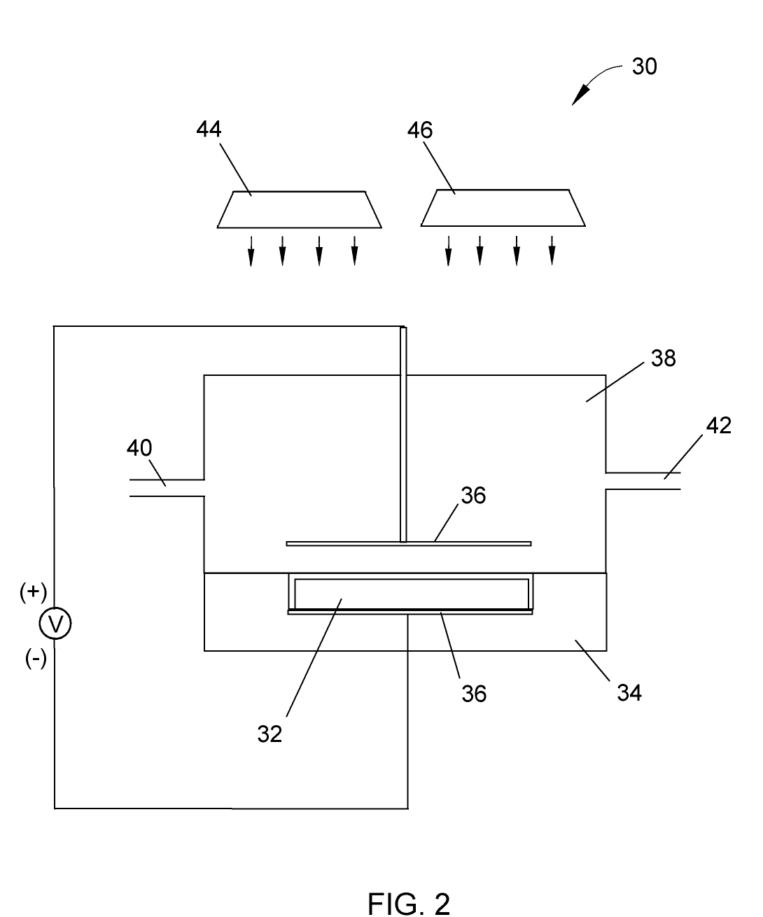

A variety of methods are capable of applying charge to materials. As an example, two electrodes separated by a dielectric can be polarized by charges induced on them through application of a voltage potential. This approach is represented in FIG. 2, in which an apparatus 30 contains a npSi storage matrix 32 in the form of a disk placed in a well within a base 34 so as to be positioned between two metal plates 36 that can be polarized by a voltage potential. The disk 32 and electrodes 36 may be enclosed within a chamber formed by the base 34 and a cover 38. The apparatus 10 is shown as being provided with an inlet 40 for inert gases such as argon, and an outlet 42 for vacuum hook-ups and/or analysis tools. The apparatus 10 may optionally be equipped with inlets for etch reagents to enable the npSi storage matrix to be formed from silicon within the chamber, and inlets for hydrogen so that the storage matrix can be charged and re-charged with hydrogen within the same chamber. The apparatus 10 can also shown as equipped with a light source 44 and heat source 46 for use during formation of the npSi and/or during hydrogen charging and recharging within the same chamber.

In the practice of the present invention utilizing charges as placeholders, as hydrogen is released (as H₂) from the npSi matrix 32, the voltage applied by the electrodes 36 allows mobile charges (electrons, or preferably holes) to replace the departing positively-charged hydrogen atoms at the matrix surface. It is anticipated that not every released hydrogen atom will require replacement by a corresponding mobile charge. Rather, just a fraction of the hydrogen atoms will likely need to be replaced by mobile charges to provide the self-repelling effect required to prevent silicon-silicon bond formation between the silicon dangling bonds in the matrix 32. The size of this fraction will depend on a number of structural, chemical, geometrical, and electrical-force factors that can be optimized for the various potential applications of the present invention. Recharge of the storage matrix 32 by hydrogen atoms can then be achieved through a reverse-directed current, in which individual hydrogen atoms, possibly “cracked” through the presence of a catalyst, are drawn to surface dangling bonds as the mobile charges thereon are withdrawn. Therefore, manipulation of electrical power applied to the matrix 32 can provide effective control over the rate of hydrogen adsorption-desorption, which is highly beneficial for applications such as a motor vehicle hydrogen storage tanks that require a sufficiently rapid and convenient recharging capability to find consumer acceptance.

When utilizing atoms as placeholders, the atoms must be physically nearby to the site of a desorbing hydrogen atom in order to bond with the silicon atom from which the hydrogen atom was desorbed. For this purpose, a vapor-phase source of placeholder atoms may be used, though a liquid solution containing placeholder atoms is preferred since individual ions are more easily transported to the silicon bond sites of the storage matrix 32. As hydrogen gas is released (as H₂), dissolved ions can readily bond with the silicon dangling bonds. This process may require the addition of energy (endothermic) or generate energy (exothermic), depending on the ion used as a placeholder and the chemistry of the solution. If endothermic, the addition of heat, light, or electric power (electrochemistry) may be required to drive the desired reaction. For hydrogen reabsorption, the chemical reaction is reversed so that hydrogen atoms displace the placeholder atoms. Again, this process can be carried out in a liquid or vapor phase, and not necessarily in the same phase as the hydrogen desorption technique used to insert the placeholder atoms. If the hydrogen displacement reaction does not occur spontaneously, additional energy must be supplied, for example, through the application of heat, light, or electric power (electrochemical process). Additionally, catalytic agents may be used to drive the hydrogen absorption reaction pathway.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims

1. A hydrogen storage process utilizing a porous solid-state hydrogen storage medium, the process comprising:
while applying a charge to the storage medium, displacing at least one hydrogen atom stored on the storage medium to create at least one dangling bond on the storage medium; and
replacing the hydrogen atom displaced from the storage medium with a placeholder, thereby preventing the dangling bond from bonding to an adjacent dangling bond within the storage medium.

2. The hydrogen storage process according to claim 1, wherein the storage medium is a porous silicon matrix.

3. The hydrogen storage process according to claim 1, wherein the charge is applied by positioning the storage medium between electrodes oppositely charged by an electrical power source.

4. The hydrogen storage process according to claim 1, wherein the placeholder is an electrical charge or an atom.

5. The hydrogen storage process according to claim 1, wherein the placeholder is an electrical charge.

6. The hydrogen storage process according to claim 5, wherein the electrical charge is a positive charge.

7. The hydrogen storage process according to claim 1, wherein the placeholder is an atom.

8. The hydrogen storage process according to claim 7, wherein the atom is a positively-charged ion.

9. The hydrogen storage process according to claim 7, wherein the atom is a lithium atom or a boron atom.

10. The hydrogen storage process according to claim 1, wherein the hydrogen atom is displaced by at least one technique chosen from the group consisting of heat energy, light energy, and electrical energy applied to the storage medium.

11. The hydrogen storage process according to claim 10, wherein the light energy comprises at least one of infrared energy and ultraviolet energy.

12. The hydrogen storage process according to claim 10, wherein the light energy is infrared energy.

13. The hydrogen storage process according to claim 1, further comprising recharging the storage medium with at least one hydrogen atom by reversing the charge applied to the storage medium in the presence of free hydrogen atoms so as to release the placeholder from the dangling bond and draw a free hydrogen atom to the dangling bond from which the placeholder was released.

14. An apparatus for carrying out a hydrogen storage process that utilizes a porous solid-state hydrogen storage medium, the apparatus comprising:
means for applying a charge to the storage medium;
means for displacing at least one hydrogen atom stored on the storage medium to create at least one dangling bond on the storage medium; and
means for replacing the hydrogen atom displaced from the storage medium with a placeholder, thereby preventing the dangling bond from bonding to an adjacent dangling bond within the storage medium.

15. The hydrogen storage apparatus according to claim 14, wherein the storage medium is a porous silicon matrix.

16. The hydrogen storage apparatus according to claim 14, wherein the charge applying means comprises electrodes between which the storage medium is positioned and an electrical power source connected to the electrodes.

17. The hydrogen storage apparatus according to claim 14, wherein the placeholder is an electrical charge or an atom.

18. The hydrogen storage apparatus according to claim 14, wherein the placeholder is an electrical charge.

19. The hydrogen storage apparatus according to claim 18, wherein the electrical charge is a positive charge.

20. The hydrogen storage apparatus according to claim 14, wherein the placeholder is an atom.

21. The hydrogen storage apparatus according to claim 20, wherein the atom is a positively-charged ion.

22. The hydrogen storage apparatus according to claim 20, wherein the atom is a lithium atom or a boron atom.

23. The hydrogen storage apparatus according to claim 14, wherein the displacing means is at least one of heat energy, light energy, and electrical energy.

24. The hydrogen storage apparatus according to claim 23, wherein the light energy comprises at least one of infrared energy and ultraviolet energy.

25. The hydrogen storage apparatus according to claim 23, wherein the light energy is infrared energy.

26. The hydrogen storage apparatus according to claim 14, further comprising means for recharging the storage medium with at least one hydrogen atom, the recharging means comprising means for reversing the charge applied to the storage medium and a source of free hydrogen atoms, the recharging means operating to release the placeholder from the dangling bond and draw a free hydrogen atom to the dangling bond from which the placeholder was released.
